(19) United States
(12) Patent Application Publication
(10) Pub. No.: US 2024/0092454 A1
(43) Pub. Date: Mar. 21, 2024

(54) Method for Operating an Electric Bike

(71) Applicant: Robert Bosch GmbH, Stuttgart (DE)

(72) Inventors: Alessandro Moia, Holzgerlingen (DE); Silas Klug, Magstadt (DE)

(21) Appl. No.: 18/468,211

(22) Filed: Sep. 15, 2023

(30) Foreign Application Priority Data
Sep. 16, 2022 (DE) 10 2022 209 772.6

(51) Int. Cl. B62M 6/50; B60T 8/17; B60T 8/1761

(52) U.S. Cl. CPC B62M 6/50; B60T 8/1706; B60T 8/1761; B62J 45/4152

(57) ABSTRACT

A method for operating an electric bike includes a braking system and a drive unit which is actuable in a controlled manner, with the braking system including an actuator which is actuable in a controlled manner for generating a braking torque in a controlled manner. The method includes generating a braking torque in a controlled manner by way of the braking system and generating a driving torque in a controlled manner by way of the drive unit. The generation of the braking torque in a controlled manner and the generation of the driving torque in a controlled manner are performed simultaneously and depending on one another in order to decelerate the electric bike at a predetermined total braking torque, or to accelerate at a predetermined total driving torque.

This application claims priority under 35 U.S.C. § 119 to patent application no. DE 10 2022 209 772.6, filed on Sep. 16, 2022 in Germany, the disclosure of which is incorporated herein by reference in its entirety.

### BACKGROUND

The present disclosure relates to a method for operating an electric bike, and to an electric bike.

Electric bikes comprising hydraulic braking systems which have actuators, by means of which a braking pressure can be generated in the braking system in a controlled manner, are known. For example, such an actuator can be part of an anti-lock braking system. The aim is in this context often to prevent the vehicle's wheels from locking by modulating the hydraulic braking pressure in the system.

### SUMMARY

The method according to the disclosure is characterized in that a particularly flexible and efficient driving operation of the electric bike can be provided. In particular, a particularly high level of riding comfort for a rider of the electric bike can thereby be enabled. According to the disclosure, this is achieved by a method for operating an electric bike, the electric bike comprising a braking system and a drive unit which is actuable in a controlled manner. In particular, the drive unit is configured to provide a motor torque in response to a pedal actuation by the rider to motorically support a pedaling force of the rider. The braking system comprises an actuator which is actuable in a controlled manner to be able to generate a braking torque in a controlled manner. Preferably, the braking system is designed as a hydraulic braking system. The method comprises the following steps:
controlled generation of a braking torque by means of the braking system, and
controlled generation of a driving torque by means of the drive unit.

The controlled generation of the braking torque and the controlled generation of the driving torque are performed simultaneously and are performed so as to be dependent on each other in order to decelerate the electric bike at a predetermined total braking torque, or to accelerate the electric bike at a predetermined total driving torque. Preferably, a braking torque and a driving torque of greater than zero each are generated simultaneously during the method.

In other words, the method involves coordinated regulation of braking torque and driving torque depending on one another. This makes it possible to provide a particularly high degree of flexibility during riding operation of the electric bike. For example, a particularly large torque range can thereby be covered by the controlled regulation when the electric bike is in riding operation. In other words, acceleration or deceleration of the electric bike can, e.g., be achieved in a flexible manner by the corresponding coordinated control of the braking system and drive unit, in particular without requiring active intervention by the rider, e.g., by means of brake lever actuation. A variety of automatic driving functions can therefore be provided in a simple and efficient manner, thus enabling a particularly high level of riding comfort for the rider of the electric bike.

Preferable embodiments of the disclosure are also set forth below.

Preferably, in a first mode of operation, the actuator of the braking system is actuated so as to generate a predetermined constant braking torque. In other words, a constant braking pressure is in particular generated in the braking system by means of the actuator. This can be achieved by shifting a working range of the drive unit as a whole towards lower torques. In other words, a torque range that enables both acceleration and deceleration of the electric bike can be covered simply by adjusting the driving torque that can be provided by means of the drive unit. For example, in this case, deceleration of the electric bike can be achieved by reducing the driving torque of the drive unit to a lower value than the constant braking torque generated by means of the braking system. A particularly high flexibility in the driving operation of the electric bike can therefore be provided by a particularly simple and effective regulation process. In particular, advantageous driving functions can be provided in a simple manner, which can be implemented by controlling the drive unit alone. For example, a traction control and/or prevention or mitigation of the effects of a lift-off of a front wheel of the electric bike can thereby be provided in a particularly simple manner.

Particularly preferably, the predetermined constant braking torque corresponds to at least 10%, preferably at most 80%, preferably at least 30%, especially preferably at most 60%, of a maximum driving torque which can be generated at most by means of the drive unit. Doing so can ensure that the sole control of the drive unit can cover a torque range that also enables sufficient deceleration of the electric bike for a wide range of driving functions.

Preferably, the generation of the predetermined constant braking torque occurs independently of a brake lever force on a brake lever of the electric bike. In particular, the brake lever is provided in order to enable manual generation of a braking pressure in the braking system. In other words, the constant braking torque is generated in the first operating mode even if there is no actuation of the brake lever. A fully automated function can therefore be provided that enables both acceleration and deceleration of the electric bike.

Further preferably, the method further comprises the step of: detecting a wheel slip, preferably of a driven or drivable wheel of the electric bike, in particular a rear wheel. The controlled generation of the driving torque, which is provided by means of the drive unit, is performed depending on the detected wheel slip. Preferably, the driving torque of the drive unit is reduced when the detected wheel slip exceeds a predetermined wheel slip limit value. In other words, traction control can be performed by the corresponding controlled actuation of the drive unit, in particular so as to reduce wheel slip. In particular, in combination with a constant braking pressure generated by the braking system, targeted braking of the spinning wheel can be achieved actively and automatically, thus providing a particularly effective traction control in a wide range of driving situations.

Particularly preferably, the method further comprises the step of: detecting a pitch angle of the electric bike. In particular, a pitch angle is considered to be a deflection of the electric bike about a transverse axis, which can be, e.g., parallel to a bottom bracket axis. The controlled generation of the driving torque is performed depending on the detected pitch angle. Preferably, the driving torque of the drive unit is reduced when the detected pitch angle exceeds a predetermined pitch angle limit value. Doing so can, e.g., prevent a front wheel of the electric bike from lifting off, or mitigate its effect. In other words, wheelie prevention can, e.g., be provided. As an alternative to a comparison of the detected pitch angle, a pitch angle change can, e.g., also be determined, whereby the driving torque is preferably reduced if the pitch angle change exceeds a predetermined limit value.

Preferably, in a second operating mode, the controlled generation of the braking torque and the controlled generation of the driving torque are performed in such a way as to keep the electric bike stationary. In other words, braking torque and driving torque are coordinated such that the electric bike is kept stationary, preferably exclusively by braking torque and driving torque. In particular, no manual brake actuation or pedal actuation by the rider of the electric bike is thus required to keep the electric bike stationary, e.g., even on inclines or declines. A particularly high level of riding comfort can therefore be provided for the rider when operating the electric bike.

Preferably, the method further comprises the step of: detecting an inclination of the electric bike, in particular relative to a horizontal line. The controlled generation of the braking torque and the controlled generation of the driving torque are performed depending on the detected inclination. Doing so makes it possible to automatically stop the electric bike on an incline or decline in a particularly simple and effective way.

Preferably, the controlled generation of the braking torque and the controlled generation of the driving torque are additionally performed depending on a total weight of the electric bike. In particular, the total weight is considered to be at least an own weight of the electric bike, and additionally a weight of the rider and a load of the electric bike. Preferably, based on the total weight and the detected inclination, a required driving torque and/or braking torque is determined to keep the electric bike stationary at the corresponding inclination. For example, the total weight can be entered manually by the rider of the electric bike. This makes it possible, in a particularly simple and efficient manner, for the electric bike to be held on inclines or declines by the automatic operation of the braking system and drive unit.

In a particularly preferred embodiment, the method further comprises the step of: reducing in a controlled manner a braking pressure generated by the braking system in response to a pedal actuation. The braking pressure is reduced such that the electric bike is accelerated by the driving torque generated by the drive unit. In other words, by coordinated regulation of driving torque and braking torque, with the braking torque being adjusted in particular by reducing the braking pressure, when the rider actuates the pedal of the electric bike, automatic starting of the electric bike from a stationary position, e.g. on an incline, is initiated.

Further preferably, the method further comprises the step of: detecting a pitch angle of the electric bike. In particular, a pitch angle is considered to be a deflection of the electric bike about a transverse axis, which can be, e.g., parallel to a bottom bracket axis. The controlled generation of the braking torque and/or the controlled generation of the driving torque is performed depending on the detected pitch angle. Preferably, the driving torque is reduced and/or the braking torque is increased when the detected pitch angle exceeds a predetermined pitch angle limit value. Alternatively preferably, a pitch angle change can, e.g., be determined, preferably reducing the driving torque and/or increasing the braking torque if the pitch angle change exceeds a predetermined limit value. Doing so makes it possible to, e.g., easily and effectively prevent a front wheel of the electric bike from lifting off, or to mitigate its effect. In other words, wheelie prevention can, e.g., be provided when the electric bike starts.

Furthermore, the disclosure leads to an electric bike comprising a braking system, preferably a hydraulic braking system, the braking system in particular comprising an actuator which is actuable in a controlled manner, a drive unit which in particular is designed to be actuated in a controlled manner, and a control unit which is configured to perform the described method.

### BRIEF DESCRIPTION OF THE DRAWINGS

The disclosure is described hereinafter with reference to exemplary embodiments in conjunction with the drawings. In the drawings, functionally equal components are in each case identified by equal reference characters. Shown are:

FIG. 1 a simplified schematic view of an electric bike in which a method according to a preferred exemplary embodiment of the disclosure is performed,

FIG. 2 a simplified schematic view of torque diagrams used in performing the method according to the preferred exemplary embodiment of the disclosure, and

FIG. 3 a simplified schematic of the electric bike of FIG. 1 during the implementation of the method according to the preferred exemplary embodiment of the disclosure on an incline.

### DETAILED DESCRIPTION

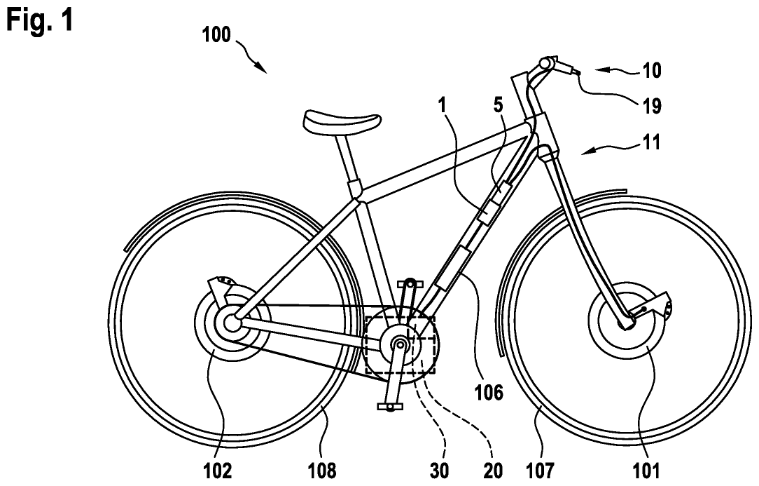

FIG. 1 shows a simplified schematic view of an electric bike 100 in which a method according to a preferred exemplary embodiment of the disclosure is performed. The electric bike 100 comprises a drive unit 20 which is configured to assist a pedaling force of a rider by means of motor power. The drive unit 20 is supplied with electrical power from an electrical power storage device 106.

The electric bike 100 comprises a hydraulic braking system 10 by means of which brakes 101, 102 can be actuated respectively on a front wheel 107 and a rear wheel 108 of the electric bike 100. The hydraulic braking system 10 comprises an anti-lock braking unit 1, which is also supplied with electrical power from the electrical power storage unit 106.

The anti-lock braking unit 1 comprises an actuator 5, by means of which a hydraulic braking pressure in the braking system 10 can be changed in a controlled manner. In particular, a braking pressure in the braking system 10 can be changed by means of the actuator 5 independently of an actuation of a brake lever 19 of the braking system 10. In other words, a braking pressure in particular can be built up and thus a braking torque can be generated without actuating the brake lever 19. In addition, a braking pressure in the braking system 10 and thus the braking torque can preferably be reduced even while the brake lever 19 is being manually actuated.

The electric bike 100 further comprises a control unit 30, which is configured to perform the method according to the disclosure. By means of the control unit 30, the controlled actuation of the actuator 5 as well as the controlled actuation of the drive unit 20 can be performed.

The method comprises at least two modes of operation, which can be performed simultaneously, for example, or alternatively independently of each other.

In a first operating mode, a predetermined constant braking torque is generated by means of the braking system 10, preferably during a ride of the electric bike 10. At the same time, a driving torque is generated by means of the drive unit 20 depending on a pedaling force manually generated by the rider of the electric bike 100.

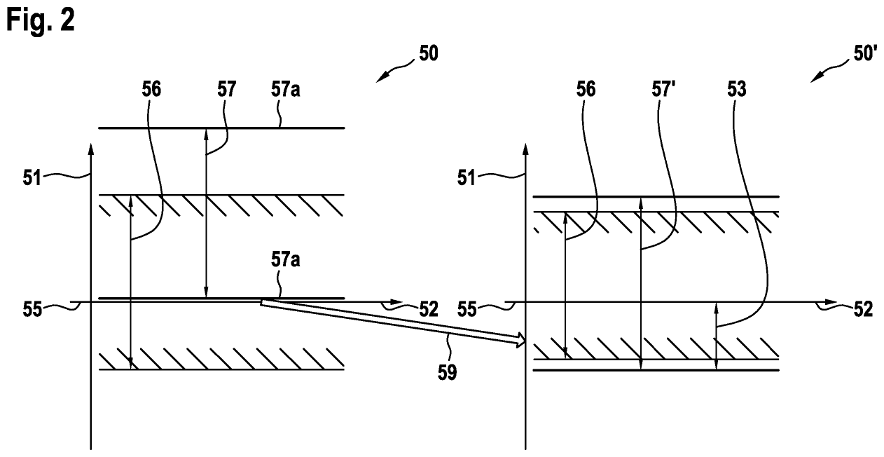

The first mode of operation is illustrated by FIG. 2 and described in detail hereinafter. FIG. 2 shows a simplified schematic view of torque diagrams 50, 50′ used in performing the method according to the preferred exemplary embodiment of the disclosure. In each of the two torque diagrams 50, 50′, a torque 51 is shown depending on a speed 52 of the electric bike 100. Line 55 indicates a torque of zero.

A first torque diagram 50, at left in FIG. 2, shows a simplified schematic view of normal operation without performing the method. The two lines 57a in this case. show a maximum value and a minimum value of a driving torque that can be generated by means of the drive unit 20. Therefore, between the two lines 57a is a torque range 57 that can be provided to the ride of the electric bike 100 by the controlled actuation of the drive unit 20. This torque range 57 extends from the zero line 55 exclusively towards positive torques 51.

When the first mode of operation of the method is performed, that is, when a constant braking torque 53 is provided by means of the braking system 10, the second torque diagram 50′ shown on the right in FIG. 2 can be provided. As can be seen in FIG. 2, the torque range 57′, which essentially corresponds to the working range of the drive unit 20 (cf. torque range 57 in the first torque diagram 50), is shifted relatively downward by the constant braking torque 53. In other words, by varying the controlled actuation of the drive unit 20, negative total torques 51 can also be provided to the electric bike 100 in this case.

As a result, advantageous driving functions of the electric bike 100, such as traction control in particular, can be provided in an improved manner. This is illustrated in FIG. 2 by the further torque range 56. This torque range 56 identifies an optimal range for performing traction control on the rear wheel 108 of the electric bike 100. As can be seen in FIG. 2, the torque range 56 also comprises negative torques 51, for example to actively brake the rear wheel 108 in the event of a very severe loss of traction.

By applying the constant braking torque 53, the total torque on the electric bike 100 that can be provided solely by varying the controlled actuation of the drive unit 20 is shifted such that the second torque range 57′ and the optimal torque range 56 for traction control are substantially congruent. In other words, the traction control can be implemented optimally just by changing the control of the drive unit 20 in an optimum manner and for a particularly wide range of applications.

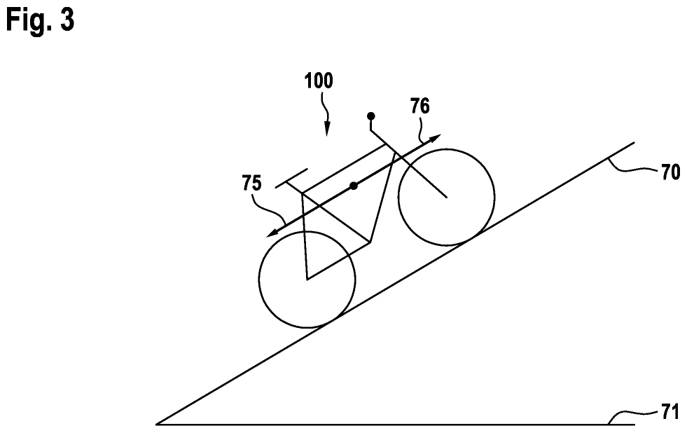

A second mode of operation of the method is described below with reference to FIG. 3. By means of the second mode of operation, stopping of the electric bike 100 at an incline 70 and starting of the electric bike 100 at the incline 70 can be provided. The method thereby detects an inclination of the electric bike relative to a horizontal line 71. Based on the detected inclination and additionally based on a total weight of the electric bike 100, the control unit 30 determines the holding force 76 required to keep the electric bike 100 stationary at the incline 70. The holding force 76 is determined such that it is equal to a slope down force 75, which is based on the inclination and total weight of the electric bike 100.

The holding force 76 can preferably be provided by the driving torque of the drive unit 20 alone, or alternatively by an additional braking torque of the braking system 10.

Preferably, the second operating mode is thereby performed exclusively during a manual actuation of the brake lever 19 of the braking system 10 of the electric bike 100. In other words, while the rider has applied the brake lever 19, the appropriately coordinated control of the braking system 10 and the drive unit 20 generates the holding force 76 in order to keep the electric bike 100 stationary at the inclination 70.

Additionally, in the second mode of operation, the starting of the electric bike 100 can be initiated by, in response to a pedal actuation by the rider of the electric bike 101, reducing the braking torque generated by the braking system 10 such that the electric bike 100 is accelerated by the driving torque of the drive unit 20. In particular, a propulsive force is generated thereby in the direction of the holding force 76 that is greater than the slope down force 75 to accelerate the electric bike 100.

Preferably, a pitch angle of the electric bike 100 can additionally be detected in both operating modes. By monitoring the pitch angle 100, the coordinated control of braking torque and driving torque can be adjusted such that undesirable driving conditions with a high pitch angle, so-called “wheelies”, can be avoided, or their effects reduced. For this purpose, in particular in response to a detection of a pitch angle that exceeds a predetermined pitch angle limit value, or alternatively or additionally in response to a detection of a predetermined minimum pitch angle change, a braking torque, in particular at the rear wheel 108, can be increased and/or the driving torque of the drive unit 20 can be reduced.

What is claimed is:

1. A method for operating an electric bike that includes a braking system and a drive unit which is actuable in a controlled manner, wherein the braking system includes an actuator which is configured to be actuable in a controlled manner for generating a braking torque in a controlled manner, said method comprising:
(a) generating a braking torque in a controlled manner by way of the braking system; and
(b) generating a driving torque in a controlled manner by way of the drive unit,
wherein step (a) and step (b) occur simultaneously and depend upon each other in order to decelerate the electric bike at a predetermined total braking torque, or to accelerate the electric bike at a predetermined total driving torque.

2. The method according to claim 1, wherein:
in a first operating mode, a predetermined constant braking torque is generated by way of the braking system.

3. The method according to claim 2, wherein the predetermined constant braking torque corresponds to at least 10% of a maximum driving torque which can be generated by way of the drive unit.

4. The method according to claim 2, wherein the generation of the predetermined constant braking torque is performed independently of a brake lever force on a brake lever of the electric bike.

5. The method according to claim 2, further comprising detecting a wheel slip,
wherein step (b) is performed depending on the detected wheel slip.

6. The method according to claim 2, further comprising detecting a pitch angle of the electric bike,
wherein step (b) is performed depending on the detected pitch angle.

7. The method according to claim 1, wherein:
in a second mode of operation, step (a) and step (b) are performed such that the electric bike is kept stationary.

8. The method according to claim 7, further comprising detecting an inclination of the electric bike, wherein:
step (a) and step (b) are performed depending on the detected inclination.

9. The method according to claim 8, wherein step (a) and step (b) are additionally performed depending on a total weight of the electric bike.

10. The method according to claim 7, further comprising:
reducing a brake pressure generated by way of the braking system in a controlled manner in response to a pedal actuation such that the electric bike is accelerated by the driving torque.

11. The method according to claim 7, further comprising detecting a pitch angle of the electric bike, wherein:
step (a) and/or step (b) is performed depending on the detected pitch angle.

12. An electric bike, comprising:
a braking system;
a drive unit; and
a control unit configured to perform a method according to claim 1.

13. The method according to claim 2, wherein the predetermined constant braking torque corresponds to at most 60% of a maximum driving torque which can be generated by way of the drive unit.

14. The method according to claim 2, further comprising detecting a wheel slip, wherein:
step (b) is performed depending on the detected wheel slip, and
the driving torque is reduced if the detected wheel slip exceeds a predetermined wheel slip limit value.

15. The method according to claim 2, further comprising detecting a pitch angle of the electric bike, wherein:
step (b) is performed depending on the detected pitch angle, and
the driving torque is reduced when the detected pitch angle exceeds a predetermined pitch angle limit value.

16. The method according to claim 7, further comprising detecting a pitch angle of the electric bike, wherein:
step (a) and/or step (b) is performed depending on the detected pitch angle, and
the driving torque is reduced and/or the braking torque is increased if the detected pitch angle exceeds a predetermined pitch angle limit value.
